(19) United States
(12) Patent Application Publication
(10) Pub. No.: US 2008/0131577 A1
(43) Pub. Date: Jun. 5, 2008

(54) Fat-Burning Soup Composition Addressed to People Who Wish to Lose Weight

(76) Inventor: Dominique Gagnant, Lyon (FR)

Correspondence Address: Dominique Gagnant, 143, Avenue Lacassagne, F-69003 Lyon, omitted

(21) Appl. No.: 11/587,464

(22) PCT Filed: Nov. 17, 2005
(86) PCT No.: PCT/FR05/02844

§ 371 Date: Jul. 30, 2007

(30) Foreign Application Priority Data
Mar. 25, 2005 (FR) 0502961

(51) Int. Cl. A23L 1/29; A23L 1/212

(52) U.S. Cl. 426/589

(57) ABSTRACT

Composition of the fat-burning soup addressed to people who wish to lose weight.

The invention concerns a composition of ingredients to make a fat-burning soup available for consumption by over-weight people who wish to lose weight. This fat-burning soup, composed of natural products, is the base of the daily nourishment for customers who want to make a fat-burning diet.

This soup can be freely consumed without quantity limitations when customers are hungry.

The present Invention concerns a composition of ingredients consumed in soup-shape and available for consumption by over-weight people who wish to lose weight.

This fat-burning soup, composed of natural products, can be freely consumed without quantity limitations.

Here there are the details of the soup composition:

Ingredients:
6 large fresh white onions.
1 Kg of peeled tomatoes (fresh or in a can)
1 big green cauliflower (or leeks or zucchinis in a equivalent volume)
2 green peppers
1 celery in branches (or fennel)
2 cubes of onion broth

Here is now the preparation and the cooking modality of this fat burning soup:
Cut vegetables in small pieces, put them in a big pan or in a pressure cooker and fill it of water.
Don't salt it.
Add pepper or even curry, chive or spicy sauce (following tastes: Tabasco, arisa).
Boil fast for 10 minutes.
Cut to simmer and continue cooking until vegetables are tender.
Mix them if you prefer.

This fat-burning soup is the base of the daily nourishment for customers.

At least 7 days of fat-burning diet are necessary for lose weight:

1^{st} Day—Just soup and bananas. Melon and watermelon are suggested because are fruits with a few of calories.

It's better to drink just natural traits juices, so that tea or coffee without sugar. Drink a lot of water.

2^{nd} Day—Customers should eat only fresh or canned vegetables, steamed or uncooked. Don't use butter or oil on the vegetables with the soup.

This evening we can eat a baked large potato with a little bit of butter or olive oil. Today we don't eat fruits.

3^{rd} Day—Today is the mix between the two previous days. Along the day, eat fruits and vegetables, except bananas. This evening we can't eat potatoes.

Results after the third day: if we have not cheated, we will find we have lost between 2.5 and 3.5kg.

4^{th} Day—Eat just the fat-burning soup, bananas and skim milk (3 bananas and 2 glasses of skim milk per day), and drink as much water as we can drink.

Bananas we eat today will help us to avoid temptation with sweets.

5^{TH} Day—Chicken without skin and 5 tomatoes. We need to drink between 5 and 8 water glasses in order to eliminate the uric acid produced by the meat. Don't forget to eat the soup at least once a day.

6^{TH} Day—Today we'll eat vegetables and meat. We eat according to our hunger. We can eat a slice of meat each meal. We consume a lot of salad with the meat, not potatoes, and the soup at least once a day.

7^{TH} Day—To finish the week, we'll eat complete rice. Eat vegetables and drink fruits juice. Eat the soup at least once a day, it's necessary.

Result after the 7^{th} day: at the end of the week, if you have not cheated, we will find we have lost between 7.5 and 8.5 kg.

If we lost more than 8 kg, we should not restart the diet immediately, but rest for at least 2 days (paying attention) and after we'll recommence.

### Accessorial Suggestions

Don't eat between the meals (fruits or other)
Eat the fruits at the beginnings of the meals.
Don't associate animal proteins among them (Ex: Meat+cheese).
Don't associate animal proteins with carbohydrates (meat+carbohydrates, pulses)
Eat pulses at noon, not the evening.

This soup can be eaten each time we are hungry. We can eat as much as we want, it doesn't add any calories.

It can be sold in shops in carton-bricks or in bottles.

1) Composition of the fat-burning soup for the loose of weight:
6 large fresh white onions.
1 Kg of peeled tomatoes (fresh or in a can)
1 big green cauliflower (or leeks or zucchinis in a equivalent volume)
2 green peppers
1 celery in branches (or fennel)
2 cubes of onion broth

2) Composition according to the claim 1 characterized in such a product, a fat-burning soup, consumed as daily dietary food for minimum duration of a week and addressed to the people who wish to lose weight.
